(19) United States
(12) Patent Application Publication
(10) Pub. No.: US 2022/0152809 A1
(43) Pub. Date: May 19, 2022

(54) SYSTEMS AND METHODS FOR DUAL SHAFTED MULTI-TOOL

(71) Applicant: DANIEL R. LUKE, Boise, ID (US)

(72) Inventor: DANIEL R. LUKE, Boise, ID (US)

(21) Appl. No.: 17/098,731

(22) Filed: Nov. 16, 2020

(51) Int. Cl. B25G 1/06; B25G 1/04; B25G 3/00; A01B 1/06

(52) U.S. Cl. CPC B25G 1/06; B25G 1/04; B26B 23/00; A01B 1/06; B25G 3/00

(57) ABSTRACT

Disclosed embodiments include a two-shafted multi-tool including a primary shaft having a D-handle at one end and a releasable tool connector at the opposite end, and a secondary shaft having a D-handle at one end and a rotating connector at the opposite end, and wherein the rotating connector couples the secondary shaft to the primary shaft substantially adjacent to the releasable tool connector. Further disclosed embodiments include at least one adjustable shaft handle that is releasably couplable to either the primary shaft or the secondary shaft.

### FIELD OF THE DISCLOSURE

This disclosure relates generally to two-shafted tools. More particularly, this disclosure relates to systems and methods for implementing a two-shafted tool to, among other things, increase the amount of control, leverage, and force a user can exert with the tool.

### BACKGROUND

Two shafted shovels are known. For example, U.S. Pat. No. 911,291 shows a two handled scoop-shovel. Typically, existing two shafted shovels feature a secondary shaft shorter than the primary (tool-bearing) shaft. Such configurations are limited in the ways the additional shaft could be useful, while in other ways actually reduce and hinder the usefulness of the tools they are intended to improve. Heretofore, the main advantage that a two shafted scoop shovel offers is in transferring material from a typically lower surface to a higher one (i.e., lifting material situated on the ground up vertically some distance onto a wagon). However, existing secondary shafts do not help to exert a downward force to penetrate a surface nor a lateral force to push material forward such as one might do with a snow shovel.

Another drawback of existing two shafted shovels is the limited articulation of connecting joints, and the overall difficulty of articulation and movement of all connecting joints in aggregate. For example, U.S. Pat. No. 911,291 allows the secondary shaft to articulate with a hinge joint that only permits back and forth motion in a single plane. Other drawbacks, inefficiencies, and issues also exist with current two handled shovels.

### SUMMARY

Accordingly, disclosed embodiments address the above, and other, drawbacks, inefficiencies, and issues of existing systems and methods. Disclosed embodiments include a two-shafted multi-tool having a primary shaft having a tool connector at one end, and a secondary shaft having a rotating connector at one end, and wherein the rotating connector couples the secondary shaft to the primary shaft substantially adjacent to the tool connector.

Further disclosed embodiments include a D-handle on the primary shaft at an end opposite from the tool connector. Further disclosed embodiments include a D-handle on the secondary shaft at an end opposite from the rotating connector. Further disclosed embodiments include at least one adjustable shaft handle that is releasably couplable to either the primary shaft or the secondary shaft. In some embodiments a rotatable connector couples the shaft handle to either the primary shaft or secondary shaft. Further disclosed embodiments include a first adjustable shaft handle that is releasably couplable to the primary shaft, and a second adjustable shaft handle that is releasably couplable to the secondary shaft. Further disclosed embodiments include a rotatable connector that couples the shaft handle to either the primary shaft or secondary shaft.

In some embodiments the rotating connector comprises at least one roller bearing. In further disclosed embodiments, the rotating connector includes a first roller bearing coupled to the primary shaft, a second roller bearing coupled to the secondary shaft, and a pivot coupling the first roller bearing and the second roller bearing. In some embodiments the rotating connector comprises at least one bushing.

Further disclosed embodiments include a secondary shaft that has a length (L2) that is greater than the length (L1) of the primary shaft. In some embodiments the length of the primary shaft is adjustable. In some embodiments the length of the secondary shaft is adjustable.

In some disclosed embodiments at least one of the D-handles has a curved portion configured to fit partially around a user's arm.

Further disclosed embodiments include a multi-tool implement that is releasably attachable to the releasable tool connector on the primary shaft. In some embodiments, the multi-tool implement may be any of the following: a hoe, a rake, a mop, a broom, an axe, a sledgehammer, a paddleboard paddle, a pool cleaning net, a Pulaski axe, or a pry bar.

Further disclosed embodiments include a two-shafted hoe having a primary shaft having a hoe blade at one end, and a secondary shaft having a rotating connector at one end, and wherein the rotating connector couples the secondary shaft to the primary shaft substantially adjacent to the hoe blade.

Further disclosed embodiments include a rotating connector having a primary shaft coupler configured to rotate about a primary shaft, a secondary shaft coupler configured to allow rotation of a secondary shaft about a central axis of the secondary shaft, and a pivoting coupler that couples the primary shaft coupler and the secondary shaft coupler and enables pivoting of the primary shaft coupler with respect to the secondary shaft coupler. In some embodiments the primary shaft coupler comprises a bushing. In some embodiments the primary shaft coupler comprises a roller bearing. Other embodiments and features also exist.

### BRIEF DESCRIPTION OF THE DRAWINGS

FIG. 1 is a schematic illustration of a two-shafted multi-tool in accordance with disclosed embodiments.

FIG. 2 is a schematic isometric view of an embodiment of modified D-handles 200 in accordance with the disclosure.

FIG. 3A is a schematic, partially transparent view of an embodiment of a rotating connector 300 in accordance with disclosed embodiments.

FIG. 3B is a schematic view of an embodiment of a rotating connector 300 in accordance with disclosed embodiments.

FIG. 4 is a schematic illustration of a two-shafted multi-tool showing relative movement of the shafts in accordance with disclosed embodiments.

FIG. 5 is a schematic, partially transparent, illustration of a rotatable shaft handle 112 in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

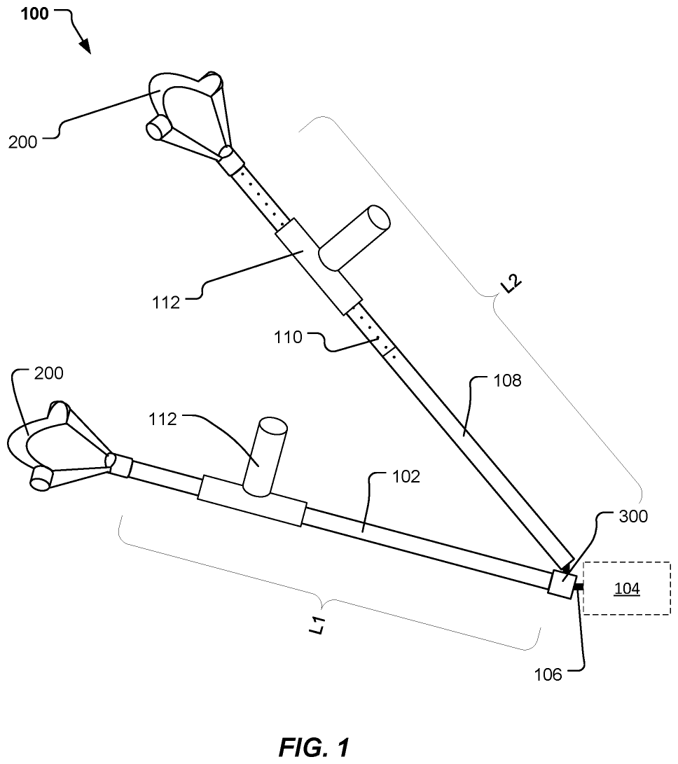

FIG. 1 is a schematic illustration of a two-shafted multi-tool 100 in accordance with disclosed embodiments. As shown, embodiments of the two-shafted multi-tool 100 include a primary shaft 102 that is connected directly to the multi-tool implement 104 (indicated schematically). The multi-tool implement 104 may be any sort of shaft mounted tool. For example, multi-tool implement 104 may be a shovel, spade, scoop, snow shovel, snow plow, rake, hoe, adze, sledge-hammer, cultivator, aerator, weeder, axe, mattock, tamper, edger, bar-digger, Pulaski axe, fire rake, prybar, broom, mop, concrete trowel, paddleboard paddle, pool skimmer, combinations of the foregoing, or the like.

In some embodiments multi-tool implement 104 may be releasably attached to the primary shaft 102 with a releasable connector 106. The releasable connector 106 may be any sort of fastening connector that allows the attachment and removal of the multi-tool implement 104 to and from the primary shaft 102. For example, releasable connector 106 may be a ball-and-detent connector (i.e., a spring-loaded ball in one part and a corresponding hole or detent in the other), a threaded connector, a snap-fit connector (i.e., with interlocking edges), a clamping connector, or the like.

Embodiments of the two-shafted multi-tool 100 also include a secondary shaft 108. Secondary shaft 108 has a length L2 that is longer, or can adjustably be made to be longer, than that of the primary shaft 102 (L1). Having a longer secondary shaft 108 has, among other things, the following advantages. First, it allows for the application of “upwards” force (e.g., lifting with a shovel), “downwards” force (e.g., slicing or chopping with a hoe or digger bar), and “lateral” force at a surface level (e.g., pushing with a broom or snow plow or pulling with a rake), “lateral” force above ground level (e.g., striking with an axe), and also sub-surface force (e.g., paddling with a paddle board paddle or cleaning a swimming pool with a net). Additionally, a longer secondary shaft 108 enables a user to position the secondary shaft underneath an arm (e.g., at an armpit) to increase leverage on the multi-tool implement 104. Other advantages also exist.

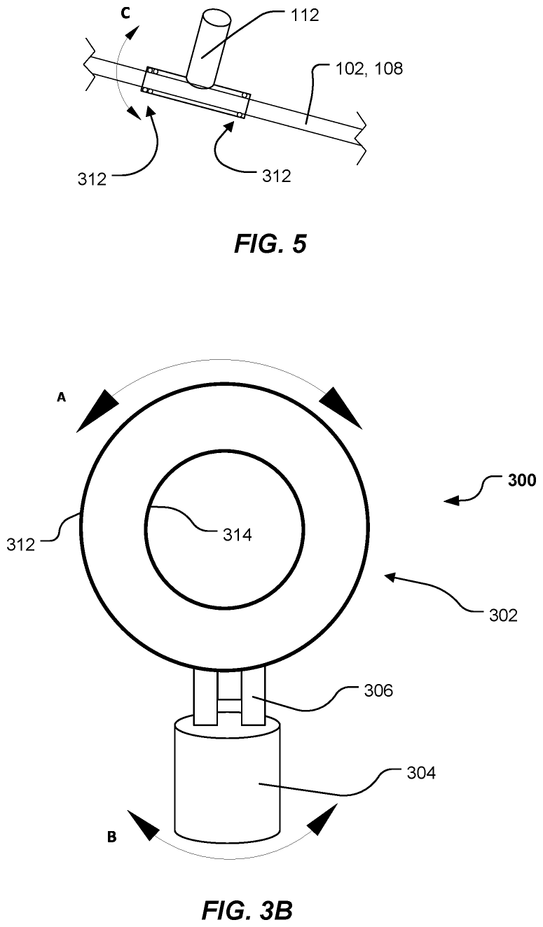

As also shown, secondary shaft 108 is connected to primary shaft 102 near the multi-tool implement 104 through rotating connector 300 discussed in more detail with respect to FIG. 3 which allows the secondary shaft 108 to rotate about the primary shaft 102 and to rotate about the center axis of the secondary shaft 108. Embodiments of rotating connector 300 also pivot as discussed with respect to FIG. 3. Among other things, the combination of pivoting and dual rotation allow for useful and comfortable positioning of the secondary shaft 108 in a wide variety of situations for a wide variety of multi-tool implements 104, an expanded repertoire of implement and user techniques, leverage, postures, terrain conditions, user size, user strength, and the like. Additionally, connecting the secondary shaft 108 to the primary shaft 102 increases the leverage, force, and range that can be applied directly near the multi-tool implement 104.

Embodiments of the secondary shaft 108 may also be adjustable in length as indicated schematically at length adjuster 110. Length adjuster 110 may be any suitable length adjusting mechanism, such as ball and detent, telescoping clamps, threaded connectors, or the like. Length adjuster 110 enables, among other things, the two-handled multi-tool 100 to be adjustable for each user, situation, multi-tool implement 104, terrain, and the like. While not shown on FIG. 1, embodiments of the two-shafted multi-tool 100 may also allow for length adjustment of the primary shaft 102.

As also shown, embodiments of the two-shafted multi-tool 100 may also include one or more shaft handles 112. Shaft handles 112 are configured to be substantially perpendicular to the long axis of the respective shaft (i.e., primary shaft 102 or secondary shaft 108) when mounted thereon. Shaft handles 112 are adjustable as to where along the respective shaft they are mounted. Mounting of the shaft handles 112 may be accomplished in any suitable, adjustable manner. For example, shaft handles 112 may have clamps, ball-and detent locks, twist lock collars, threaded connections, or the like. Among other things, shaft handles 112 enable a user to position the shaft handles 112 in a convenient location to apply an effective pushing, pulling, or twisting force as desired by the user, situation, terrain, multi-tool implement 104, or the like. Additionally, shaft handles 112 can be removed for scenarios where they are not needed or prove to be inconvenient.

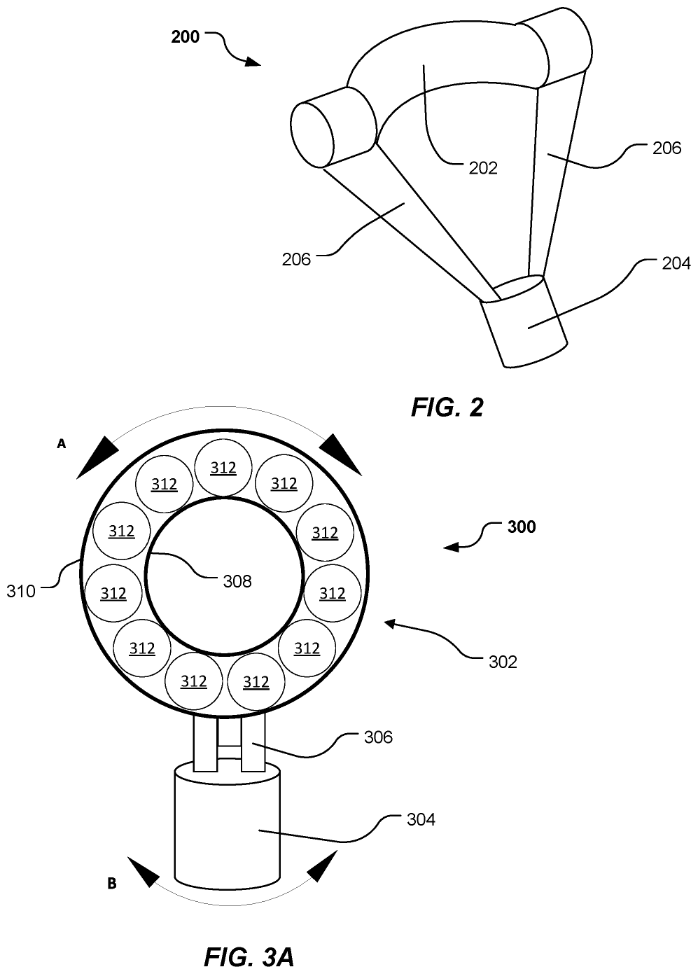

As also shown, embodiments of the two-shafted multi-tool 100 may also include one or more uniquely modified D-handles 200 to enable a user to grasp and use the two-shafted multi-tool 100 as desired. Additional disclosure of the D-handles 200 is discussed below in connection with FIG. 2.

FIG. 2 is a schematic isometric view of an embodiment of modified D-handles 200 in accordance with the disclosure. As shown, D-handles 200 include a curved portion 202 that is advantageously curved to fit around a user's arm (e.g., under a forearm, behind the triceps at the back of the upper arm, or the like). Among other things, this allows the user to apply additional leverage or force on one or both of the primary shaft 102 and secondary shaft 108. Additionally, curved portion 202 is easily graspable by hand.

As also shown, D-handles 200 include a shaft coupling portion 204 that enables attachment of the D-handles 200 to the primary shaft 102 and the secondary shaft 108. One or more connecting portions 206 may couple the shaft coupling portion 204 to the curved portion 202. Other configurations are also possible.

FIG. 3A is a schematic, partially transparent view of an embodiment of a rotating connector 300 in accordance with disclosed embodiments. As discussed above, rotating connector 300 couples primary shaft 102 and secondary shaft 108 and includes a primary shaft coupler 302 and a secondary shaft coupler 304. Primary shaft coupler 302 and secondary shaft coupler 304 are connected to each other through pivot 306. Embodiments of pivot 306 may be a hinge (i.e., allowing motion in a single plane), a ball-and-socket (i.e., allowing motion in several planes), or the like. In some embodiments pivot 306 may also enable a quick release of the primary shaft 102 from the secondary shaft 108 by including a cotter pin, being threaded, or the like.

As shown schematically and partially transparent in FIG. 3A, embodiments of primary shaft coupler 302 may be a roller bearing or the like. For example, embodiments of primary shaft coupler 302 may include an inner race 308, and outer race 310, and one or more rollers or balls 312. Inner race 302 couples to primary shaft 102 through any suitable connection, such as, for example, a friction fit, a threaded coupling, a permanent connection (e.g., a weld), or the like. As also shown, pivot 306 is connected to outer race 310 and permits 360° rotation of the pivot 306 about the central axis of the outer race 310 (indicated schematically by arrow A). Similarly, embodiments of rotating coupler 300 may also include a roller bearing, or the like, as a secondary shaft coupler 304 that permits 360° rotation of the secondary shaft 108 about its own central axis (indicated schematically by arrow B).

FIG. 3B is a schematic view of an embodiment of a rotating connector 300 in accordance with disclosed embodiments. As shown for these embodiments, primary shaft coupler 302 may also comprise a bushing 312 or the like. For these embodiments, an inner surface 314 of bushing 312 may fit snugly over primary shaft 102 and permit 360° rotation of the pivot 306 about the central axis of the bushing 312 (indicated schematically by arrow A). Other configurations are also possible.

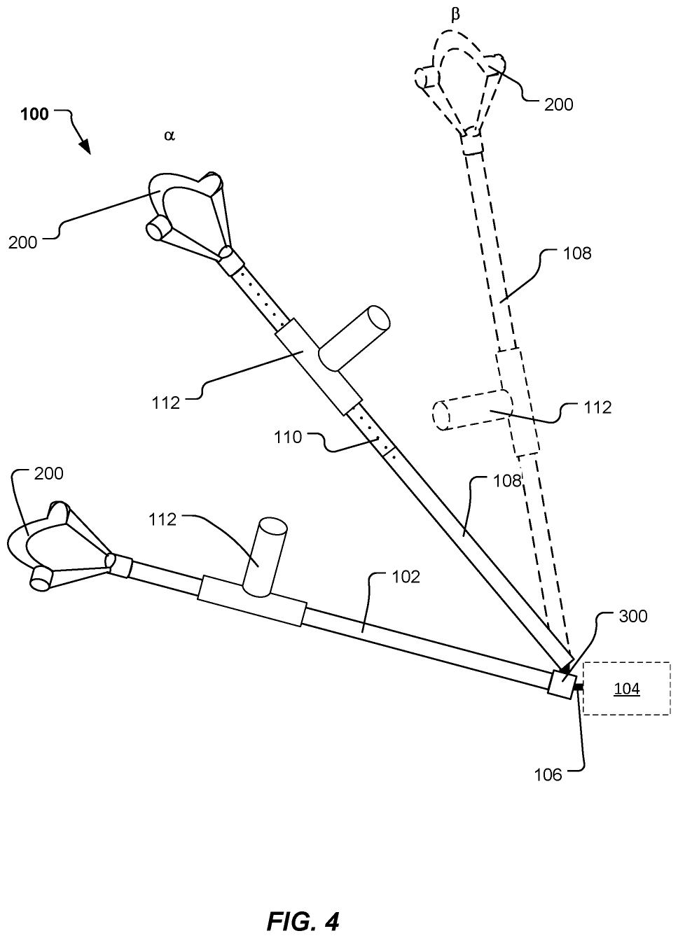

FIG. 4 is a schematic illustration of a two-shafted multi-tool 100 showing relative movement of the shafts in accordance with disclosed embodiments. As indicated in dashed lines, secondary shaft 108 has moved and rotated from initial position α to a second position β. Of course, this schematic is merely exemplary, and a wide range of other orientations and positions are also possible.

FIG. 5 is a schematic, partially transparent, illustration of a rotatable shaft handle 112 in accordance with disclosed embodiments. As indicated schematically, embodiments of the two-shafted multi-tool 100 may also have shaft handles 112 that rotate on a fixed shaft (e.g., primary shaft 102 or secondary shaft 108) by using a rotatable connector, such as a roller bearing (e.g., indicated by rollers or balls 312), or the like, to enable independent rotation of the shaft handle 112 (e.g., around the shaft as indicated by arrow C) irrespective of whether the shaft (e.g., 102, 108) also rotates. Other configurations are also possible.

Although various embodiments have been shown and described, the present disclosure is not so limited and will be understood to include all such modifications and variations would be apparent to one skilled in the art.

What is claimed is:

1. A two-shafted multi-tool comprising:
a primary shaft having a tool connector at one end; and
a secondary shaft having a rotating connector at one end, and wherein the rotating connector couples the secondary shaft to the primary shaft substantially adjacent to the tool connector.

2. The two-shafted multi-tool of claim 1 comprising:
a D-handle on the primary shaft at an end opposite from the tool connector.

3. The two-shafted multi-tool of claim 1 comprising:
a D-handle on the secondary shaft at an end opposite from the rotating connector.

4. The two-shafted multi-tool of claim 1 further comprising:
at least one adjustable shaft handle that is releasably couplable to either the primary shaft or the secondary shaft.

5. The two-shafted multi-tool of claim 4 further comprising:
a first adjustable shaft handle that is releasably couplable to the primary shaft; and
a second adjustable shaft handle that is releasably couplable to the secondary shaft.

6. The two-shafted multi-tool of claim 1 wherein the rotating connector comprises at least one roller bearing.

7. The two-shafted multi-tool of claim 6 wherein the rotating connector comprises:
a first roller bearing coupled to the primary shaft;
a second roller bearing coupled to the secondary shaft; and
a pivot coupling the first roller bearing and the second roller bearing.

8. The two-shafted multi-tool of claim 1 wherein the rotating connector comprises at least one bushing.

9. The two-shafted multi-tool of claim 1 wherein the secondary shaft has a length (L2) that is greater than the length (L1) of the primary shaft.

10. The two-shafted multi-tool of claim 1 wherein the length of the primary shaft is adjustable.

11. The two-shafted multi-tool of claim 1 wherein the length of the secondary shaft is adjustable.

12. The two-shafted multi-tool of claim 2 wherein the D-handle has a curved portion configured to fit partially around a user's arm.

13. The two-shafted multi-tool of claim 1 wherein the tool connector is a releasable tool connector.

14. The two-shafted multi-tool of claim 13 further comprising a multi-tool implement that is releasably attachable to the releasable tool connector on the primary shaft.

15. The two-shafted multi-tool of claim 14 wherein the multi-tool implement is a hoe.

16. The two-shafted multi-tool of claim 14 wherein the multi-tool implement is a rake.

17. The two-shafted multi-tool of claim 14 wherein the multi-tool implement is a mop.

18. The two-shafted multi-tool of claim 14 wherein the multi-tool implement is a broom.

19. The two-shafted multi-tool of claim 14 wherein the multi-tool implement is an axe.

20. The two-shafted multi-tool of claim 14 wherein the multi-tool implement is a sledgehammer.

21. The two-shafted multi-tool of claim 14 wherein the multi-tool implement is a paddleboard paddle.

22. The two-shafted multi-tool of claim 14 wherein the multi-tool implement is a pool cleaning net.

23. The two-shafted multi-tool of claim 14 wherein the multi-tool implement is a Pulaski axe.

24. The two-shafted multi-tool of claim 14 wherein the multi-tool implement is a pry bar.

25. The two-shafted multi-tool of claim 4 comprising:
a rotatable connector that couples the shaft handle to either the primary shaft or secondary shaft.

26. A two-shafted hoe comprising:
a primary shaft having a hoe blade at one end; and
a secondary shaft having a rotating connector at one end, and wherein the rotating connector couples the secondary shaft to the primary shaft substantially adjacent to the hoe blade.

27. A rotating connector comprising:
a primary shaft coupler configured to rotate about a primary shaft;
a secondary shaft coupler configured to allow rotation of a secondary shaft about a central axis of the secondary shaft; and
a pivoting coupler that couples the primary shaft coupler and the secondary shaft coupler and enables pivoting of the primary shaft coupler with respect to the secondary shaft coupler.

28. The rotating connector of claim 27 wherein the primary shaft coupler comprises a bushing.

29. The rotating connector of claim 27 wherein the primary shaft coupler comprises a roller bearing.
